(19) United States
(12) Patent Application Publication
(10) Pub. No.: US 2015/0161897 A1
(43) Pub. Date: Jun. 11, 2015

(54) Apparatus for Communication of Emotions by Displaying Visual Representations of Emotions

(71) Applicant: Stephen Santoro, Haverhill, MA (US)

(72) Inventor: Stephen Santoro, Haverhill, MA (US)

(21) Appl. No.: 14/564,033

(22) Filed: Dec. 8, 2014

Related U.S. Application Data
(60) Provisional application No. 61/913,822, filed on Dec. 9, 2013.

(51) Int. Cl. G09B 1/38; G09B 1/36; G09B 19/00

(52) U.S. Cl. CPC G09B 1/38; G09B 19/00; G09B 1/36

(57) ABSTRACT

Apparatus for visual expression and communication of emotions is provided. The apparatus may comprise a figurine and removable and swappable heads, each head with a facial expression representing expression of an emotion. Apparatus may be presented in other forms. The apparatus may have various means of attaching the heads to the body element of the apparatus. The body may be carried by the user in any of several means, including means for attaching the body to the user, or another item carried by the user. The apparatus may include various means to organize and transport the heads or facial elements.

### FIELD OF THE INVENTION

The presently disclosed subject matter relates to the field of educational, interactive toys, and more specifically to educational and interactive toys for expressing and communicating emotions, in particular for people of all ages with autism spectrum disorder or other inhibitions to the expression of emotion, and for people who work with or regularly interact with any such individuals.

### BACKGROUND OF THE INVENTION

Communication of emotions is a fundamental requirement for healthy functioning in a society, and for living a happy and healthy life. Socially acceptable expression of emotion is learned from birth by infants, and through childhood and even adulthood, through interactions with family and friends, and through playing games and with toys.

For some people, learning to communicate or express emotions is challenging. For children with an autism spectrum disorder (“ASD”), expressing emotions is particularly difficult. The social skills required to navigate common situations, such as speaking with another person, waiting in line, or sitting still in a classroom, are often made more challenging by the fact that a person with an ASD may have difficulty expressing emotions or feelings at any given moment. The result is that, without the emotional cues and context, other people interacting with the person with ASD may have difficulty interpreting the words or actions or understanding the intent of the person with ASD.

Improving the daily lives of people with ASD is a challenge that has required creative problem-solving. Assisting people with ASD to learn to “generalize” learned social skills from a classroom or therapy session to a real-life situation (that is, to apply skills learned in a controlled environment to different but similar stimuli, in order to respond appropriately in a complex situation) has been a challenge. Without success in these efforts, people with ASD will continue to face social hurdles to full and healthy participation in society. While attempts have been made to design methods or apparatus to assist people with ASD (and others who have difficulty expressing emotion) in communicating their emotions, considerable improvements could be had in ease of use, in portability, and in quick and thorough comprehension by others. Additionally, the current art is lacking in being enjoyable to use.

### SUMMARY OF THE INVENTION

The present invention meets all these needs, by disclosing apparatus for communicating emotions by means of displaying visual representations of emotions. The inventive apparatus is easy to use: a user carries or transports a body and puts on it a head. Each of a plurality of heads, also referred to as emotion exhibiters, has a depiction of a face expressing an emotion. By swapping heads, the user can easily and non-verbally communicate a range of emotions. The apparatus is highly portable, comprising a figurine or other body representation, and a plurality of head items, each of the plurality of heads exhibiting an emotion. The body and the heads may be built with a range of means of storing and transporting them.

The present invention also provides a means of expressing emotions that is quickly recognized by others, even those not familiar with the inventive apparatus. By representing emotions utilizing facial expressions that are familiar and easily-recognizable, the head components of the inventive apparatus will be seen and understood quickly. Lastly, the present invention is enjoyable to use, as it can be presented in a fun form that will encourage its wider use. It will find users not just among those with ASD or who otherwise have difficulty expressing emotions, but also among parents and caretakers of any such individuals, and among professionals working with such individuals, such as teachers, therapists, counselors, and doctors.

These aspects of the present invention, and other disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments, but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIGS. 1A-1C show multiple views of preferred embodiments of the present invention, with a side elevation in FIG. 1A, an exploded front elevation in FIG. 1B, and an exploded side perspective view of a different preferred embodiment in FIG. 1C.

FIGS. 2A-2C illustrate exploded side perspective views of the connection and connection means between the body component and the emotion exhibiter components of the present invention, with FIG. 2A, FIG. 2B, and FIG. 2C showing three different embodiments of said connection means.

FIG. 3 depicts front elevation views of multiple emotion exhibiters of the present invention, illustrating a different representation of emotion on each.

FIGS. 4A-4B show front perspective views of emotion exhibiter components of the inventive apparatus, with FIG. 4A and FIG. 4B showing different embodiments of means for organizing the plurality of emotion exhibiters.

FIG. 5 illustrates a front perspective view of another preferred means of organizing the plurality of emotion exhibiters.

FIG. 6A and FIG. 6B illustrate front perspective views of two embodiments of another preferred means of organizing the plurality of emotion exhibiters.

FIG. 7 depicts an exploded side perspective view of a preferred means of securing and transporting the inventive apparatus.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

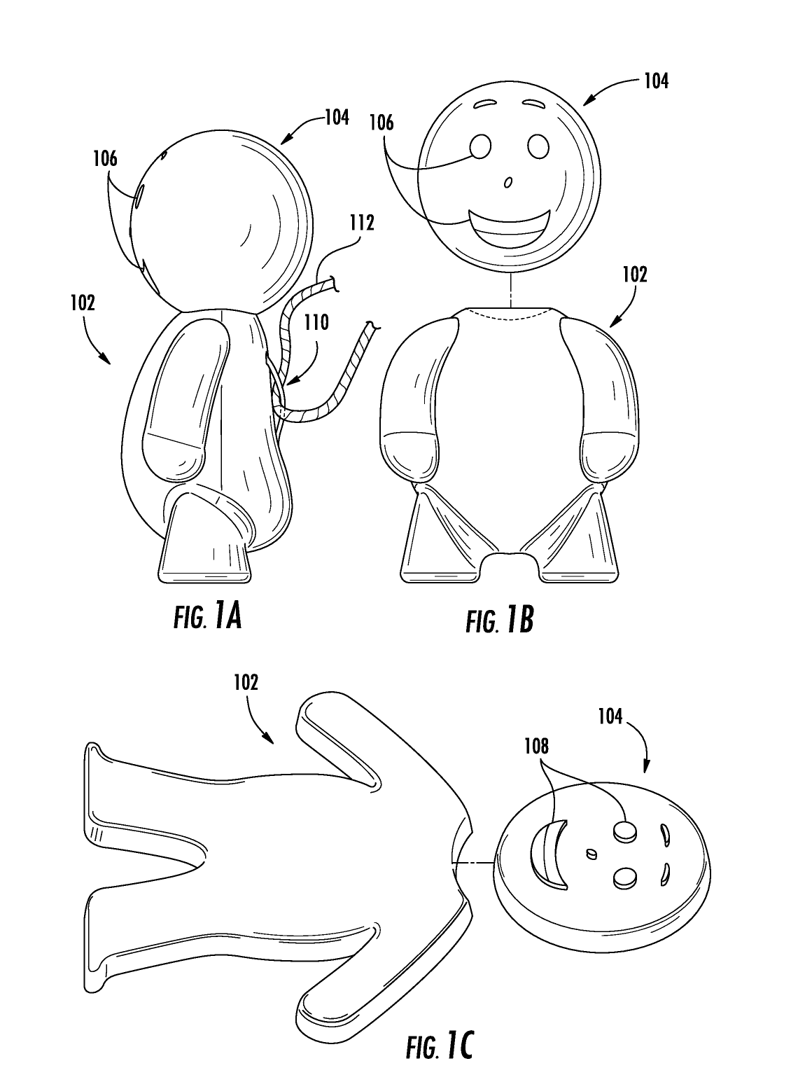

The present subject matter discloses an apparatus for the communication of emotions, by displaying visual representations of emotions. In a preferred embodiment of the present invention, as shown in FIGS. 1A-1C, the apparatus comprises a body 102 and an emotion exhibiter 104. In a preferred embodiment of the invention, the body 102 may be shaped as a rounded figurine or doll (specifically, a rounded humanoid torso, arms, and legs), and the emotion exhibiter 104 may be shaped as a spherical or nearly spherical head (specifically, a rounded humanoid head), as depicted in FIG. 1A and FIG. 1B. In other embodiments of the invention, the body 102 may be formed as a flattened outline shape of a humanoid body (specifically, a torso, arms, and legs), and the emotion exhibiter 104 may be formed as a flattened outline shape of a humanoid head. It will be obvious to one of skill in the art that other embodiments of the present invention are possible.

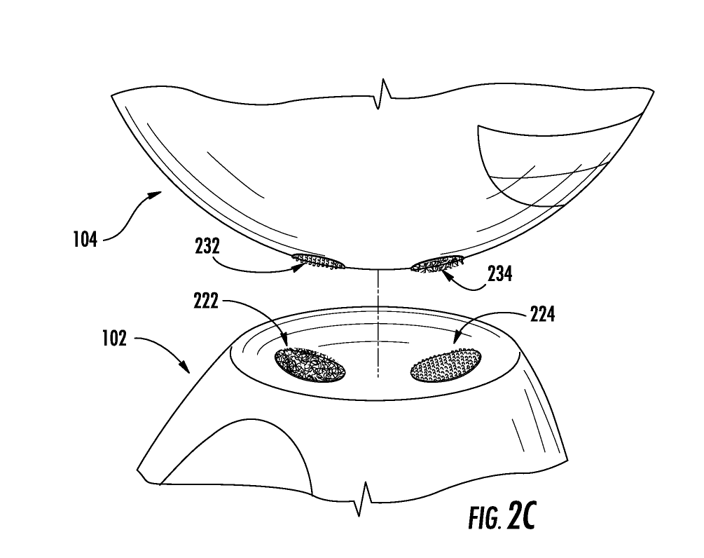

The emotion exhibiters 104 may further comprise facial features, depicting a range of emotions or emotional states. In a preferred embodiment of the invention, the facial features may comprise a plurality of facial surface variations 106 on the surface of the plurality of emotion exhibiters 104, as depicted in FIG. 1A and FIG. 1B, including but not limited to etching or cross-hatching of the surface of the plurality of emotion exhibiters 104, or altering or adding to the material used in forming the emotion exhibiters 104. In another embodiment of the invention, the facial features may comprise a plurality of facial elevational changes 108 on the surface of the plurality of emotion exhibiters 104, as depicted in FIG. 1C. Other embodiments of the claimed facial features are possible, including but not limited to printing of facial features directly on the emotion exhibiters 104. FIG. 3 depicts a representative range of facial features which may be depicted on the plurality of emotion exhibiters 104, illustrating a range of emotions, and allowing a user of the apparatus of the present invention to non-verbally express any of those emotions quickly and clearly.

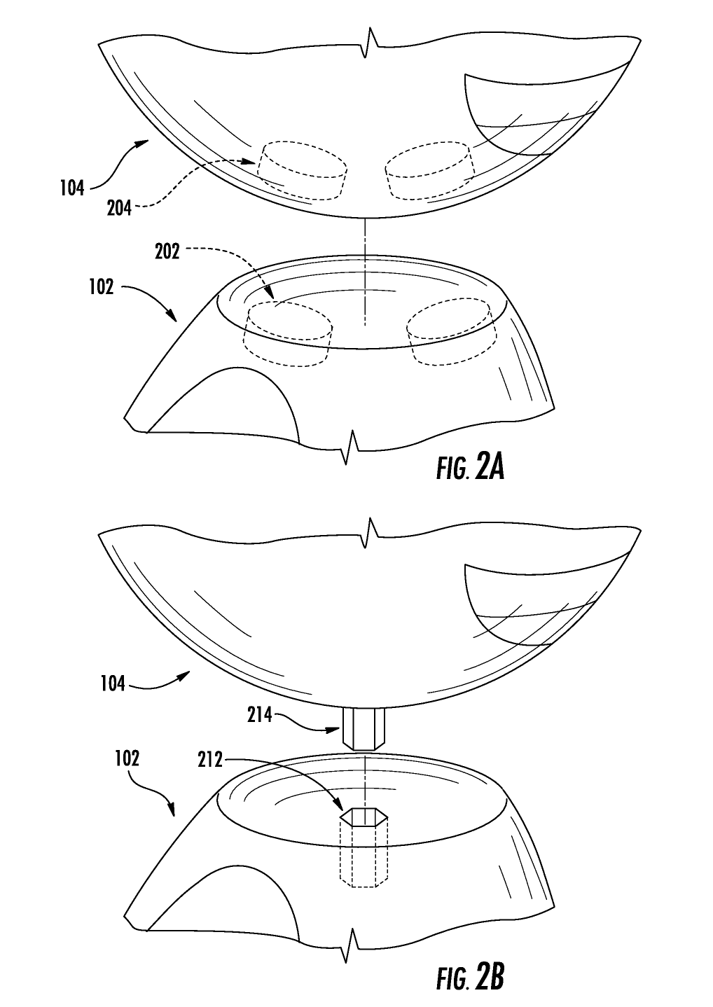

The body 102 and the plurality of emotion exhibiters 104 may be reversibly connected to each other by a connection means or a plurality of connection means, as depicted in FIG. 2A, FIG. 2B, and FIG. 2C. That is, each of the plurality of emotion exhibiters 104 may be attached to the body 102 using said connection means, and detached from the body 102, repeatedly and without degrading the functioning of either the body 102 or the plurality of emotion exhibiters 104. This functionality in the inventive apparatus allows a user to non-verbally express any of the plurality of emotions quickly and clearly, by selection of the desired one of the plurality of emotion exhibiters 104, and connection of said desired emotion exhibiter 104 to the body 102. By suitably disposing the connection means within the body 102 and the plurality of emotion exhibiters 104, each of the plurality of emotion exhibiters 104 may be constrained to be attached to the body 102 in only a desired orientation, for instance, only with the facial features of the emotion exhibiter 104 oriented towards the front of the body 102 and not towards the side or rear of the body 102. It will be obvious to one of skill in the art that other orientations may be desired, and that a plurality of desired orientations may exist for some embodiments of the present invention. The connection means, as it will be obvious to one of skill in the art, may be any of a variety of forms or types.

For a preferred embodiment of the invention, FIG. 2A depicts connection means comprising a plurality of body magnets 202 and a plurality of emotion exhibiter magnets 204, disposed respectively in the body 102 and in one of the plurality of emotion exhibiters 104. The body magnets 202 and the emotion exhibiter magnets 204 are suitably disposed in the body 102 and emotion exhibiter 104, respectively, such that each of the plurality of emotion exhibiters 104 may be reversibly connected to the body 102 in a desired orientation. For instance, and without limiting the foregoing, this may be achieved by placing various of the plurality of body magnets 202 in different magnetic orientations, such that the north pole of one of the body magnets 202 points up relative to the body 102 and the north pole of another of the body magnets 202 points down relative to the body 102, and with the north poles of the corresponding emotion exhibiter magnets 204 pointing up and down, respectively, so that the emotion exhibiter 104 and the body 102 may be connected in a desired orientation. The north poles of the body magnets 202 and of the emotion exhibiter magnets 204 may instead, in a preferred embodiment of the present invention, be oriented perpendicular to a hypothetical plane tangent to the surface of the body 102 or emotion exhibiter 104, respectively, at the point on said surface where a hypothetical line along the polar axis of each of the plurality of body magnets 202 and emotion exhibiter magnets 204 touches said surface. In these preferred embodiments of the invention, each of the plurality of emotion exhibiters 104 would have a plurality of emotion exhibiter magnets 204 so disposed, such that each of the plurality of emotion exhibiters 104 could be reversibly connected to the body 102.

In another embodiment of the invention, the connection means between the body 102 and the plurality of emotion exhibiters 104 may comprise an indentation 212 and a corresponding protrusion 214, as depicted in FIG. 2B. The indentation 212 may be disposed in the body 102, and the protrusion 214 may be disposed extending from a surface of the plurality of emotion exhibiters 104, such that each of the plurality of emotion exhibiters 104 may be reversibly connected to the body 102 in a desired orientation. In a preferred embodiment, the protrusion 214 may extend perpendicularly from the plurality of emotion exhibiters 104 at the lower surface of the plurality of emotion exhibiters 104 analogous to the neck of a humanoid, and be sized and shaped to fit snugly in the indentation 212 of the body 102, with the indentation 212 in the upper surface of the area of the body 102 analogous to the neck of a humanoid. The indentation 212 and protrusion 214 may be regular hexagons, as depicted in FIG. 2B, or may be another regular or irregular shape, as will be obvious to one of skill in the art, to constrain the reversible connection of the body 102 and the plurality of emotion exhibiters 104 to a plurality of desired orientations.

In yet another embodiment of the present invention, the connection means between the body 102 and the plurality of emotion exhibiters 104 may comprise hook-and-loop connectors, configured as a plurality of hook-and-loop areas, as depicted in FIG. 2C, with a first plurality of said hook-and-loop areas positioned on the body 102, and a second plurality of said hook-and-loop areas positioned on the plurality of emotion exhibiters 104. Said first plurality of hook-and-loop areas may comprise a body loop area 222 and a body hook area 224 disposed on the body 102. Said second plurality of hook-and-loop areas may comprise an emotion exhibiter hook area 232 and an emotion exhibiter loop area 234 disposed on the plurality of emotion exhibiters 104. Said body loop area 222 and said emotion exhibiter hook area 232 may be sized and oriented to align with and reversibly connect with each other, and said body hook area 224 and said emotion exhibiter loop area 234 may be sized and oriented to align with and reversibly connect with each other, such that each of the plurality of emotion exhibiters 104 may be reversibly connected to the body 102 in a plurality of desired orientations. It will be obvious to one of skill in the art that other embodiments or arrangements of the first plurality of said hook-and-loop areas positioned on the body 102 and of the second plurality of said hook-and-loop areas positioned on the plurality of emotion exhibiters 104 are possible.

Any of the connection means for reversibly connecting the body 102 with the plurality of emotion exhibiters 104 described with particularly herein may be combined, or other connections means now known or later invented may be implemented in other embodiments of the invention. For instance, and without limiting the foregoing, the indentation 212 and the protrusion 214 may be combined with the body magnets 202 and the emotion exhibiter magnets 204, or the indentation 212 and the protrusion 214 may have magnets placed, respectively, in the body 102 just beneath or next to the indentation 212, and in the protrusion 214 at the end, such that the reversible connection of the indentation 212 and the protrusion 214 may be supplemented by means of a magnetic reversible connection. It will be obvious to one of skill in the art that other embodiments of the reversible connection of the present invention are possible.

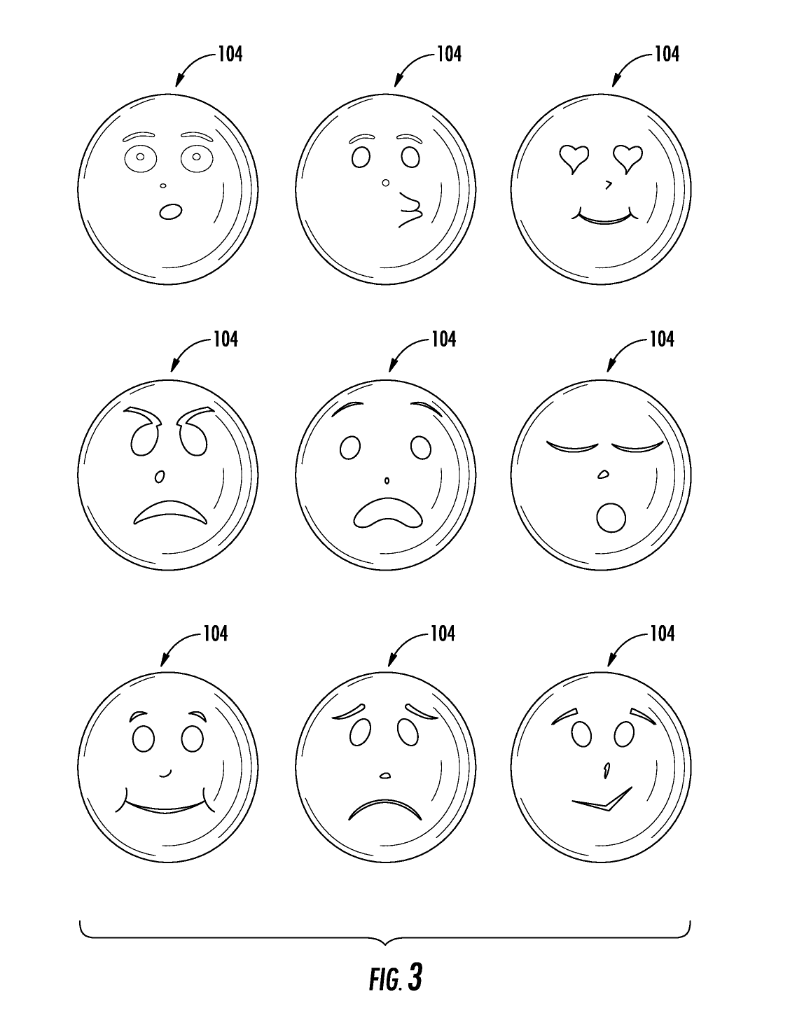

In a preferred embodiment of the inventive apparatus, the organizing means, for organizing the plurality of emotion exhibiters 104, may comprise a plurality of holes 402 through each of the plurality of emotion exhibiters 104, as illustrated in FIG. 4A, oriented such that an organizing rope 410 can be threaded through a plurality of the emotion exhibiters, passing from one emotion exhibiter 104 to a next emotion exhibiter 104. In this embodiment of the present invention, the organizing rope 410 may be a string, lanyard, chain, or other item suitable for flexibly being passed or threaded through each of the plurality of holes 402 through each of the plurality of emotion exhibiters 104, with said organizing rope 410 then securely latched or closed to form a loop, such that the plurality of emotion exhibiters 104 are held together and may be transported or stored securely.

In a preferred embodiment of the inventive apparatus, the organizing means, for organizing the plurality of emotion exhibiters 104, may comprise a plurality of emotion exhibiter organizer magnets 404, as illustrated in FIG. 4B, in each of the plurality of emotion exhibiters 104, oriented such that two or more of the plurality of emotion exhibiters 104 may be reversibly connected to each other, in a grid or close packing arrangement. It will be obvious to one of skill in the art that other arrangements of the emotion exhibiter organizer magnets 404 beyond those illustrated in FIG. 4B are possible or desirable in other embodiments of the invention, such that the plurality of emotion exhibiters 104 are held together and may be transported or stored securely.

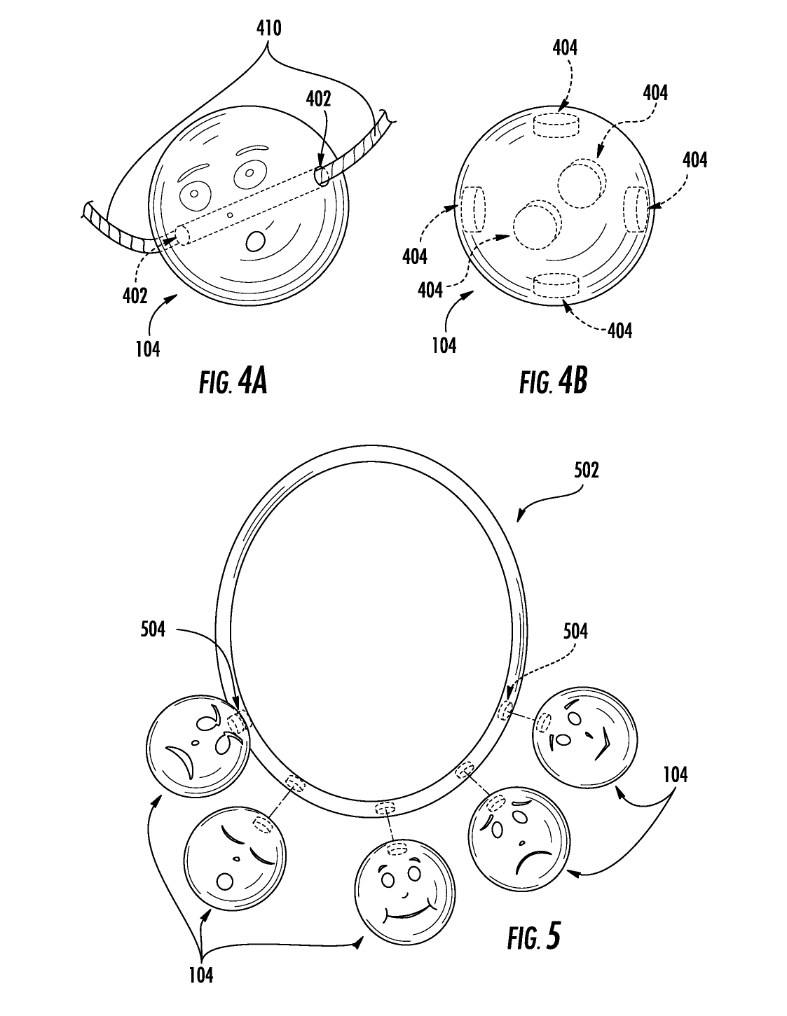

In another embodiment of the present invention, the organizing means, for organizing the plurality of emotion exhibiters 104, may comprise a carrier item 502 with carrier attachment means 504 to reversibly connect the plurality of emotion exhibiters 104 to the carrier item 502, as illustrated in FIG. 5. In some embodiments of the present invention, the carrier item 502 may be a lanyard or strap suitable for wearing by a user around the neck. In other embodiments of the invention, the carrier item 502 may be rigid, semi-rigid, or a type of chain comprising a plurality of linked items, and may be shaped as a loop, a handle, a bag, a plate, a bowl, or other suitable shape, as will be apparent to one skilled in the art. In all forms of the carrier item 502, the carrier attachment means 504 may be any means now known or later invented for reversibly connecting the plurality of emotion exhibiters 104 to the carrier item 502, such that the plurality of emotion exhibiters 104 are held together and may be transported or stored securely. Without limiting the foregoing, in a preferred embodiment of the present invention, the carrier attachment means 504 may comprise a plurality of magnets disposed throughout the carrier item 502, in which said magnetic carrier attachment means 504 are oriented to reversibly connect to corresponding magnets in a plurality of emotion exhibiters 104 and to orient the plurality of emotion exhibiters 104 in a desired manner.

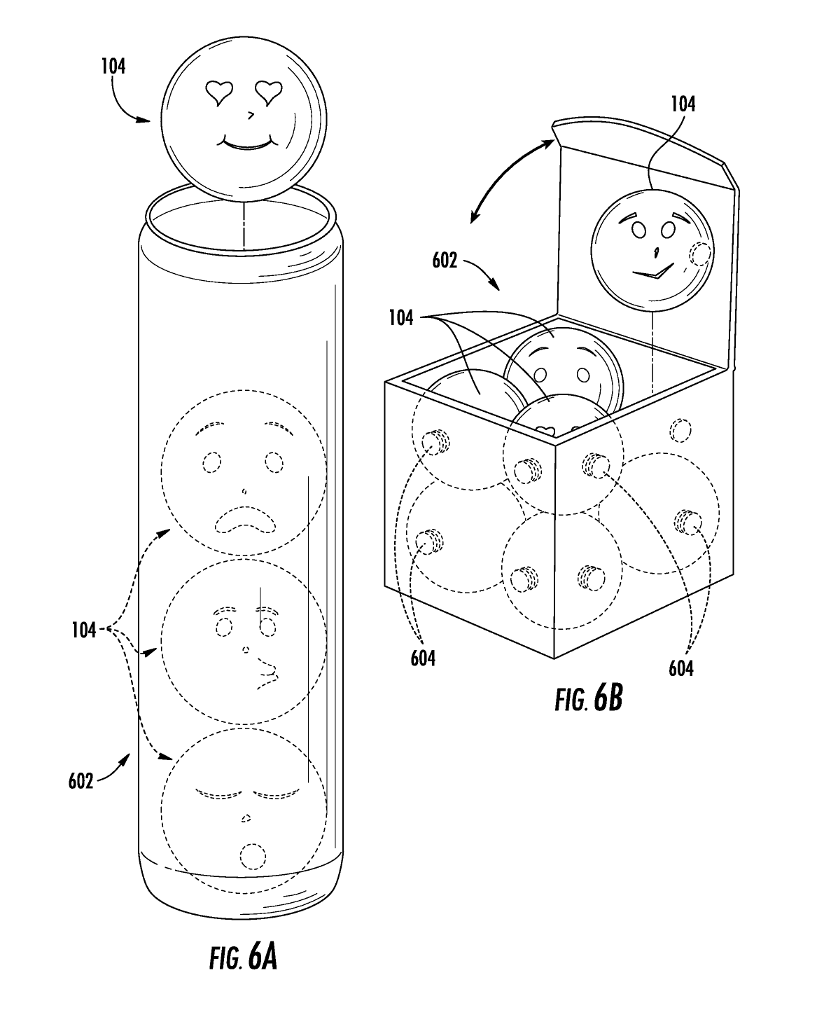

In another embodiment of the present invention, the organizing means, for organizing the plurality of emotion exhibiters 104, may comprise a container 602, illustrated in FIG. 6A as a cylindrical object and illustrated in FIG. 6B as a box with a hinged top, into which container 602 the plurality of emotion exhibiters 104 may be placed. As will be apparent to one skilled in the art, the container 602 may comprise a range of suitable shapes beyond those illustrated in FIG. 6A or in FIG. 6B. In other embodiments of the present invention, it may be desirable to have a container 602 further comprising container attachment means 604, by which each of the plurality of emotion exhibiters 104 may be secured in the container 602. Such container attachment means 604 may comprise magnetic, hook-and-loop, or other attachment means for securing the plurality of emotion exhibiters 104, and as will be apparent to one of skill in the art, such container attachment means 604 may be placed on the interior surfaces of the container 602, or within the walls of the container 602, as is illustrated in FIG. 6B with magnets as the container attachment means 604. One with skill in the art will recognize that the type of container attachment means 604 selected in a given embodiment of the present invention will vary with the type of connection means selected in that embodiment of the invention for reversibly connecting the body 102 with the plurality of emotion exhibiters 104. In all embodiments of the container 602 of the present invention, the plurality of emotion exhibiters 104 are held together and may be transported or stored securely.

In preferred embodiments of the present invention, it is desirable to have the body 102 further comprise body linking means 110, for reversibly connecting the body 102 to another object, as illustrated in FIG. 1A. It will be obvious to one of skill in the art that the body linking means 110 may be a loop of fabric or strapping, or an extension of the material comprising the body 102 itself, or another type of material. Without limiting the foregoing, it may be desirable in some embodiments of the present invention to have the body linking means 110 comprise a spring-closed latch or other suitable means for attachment to an external cord 112 or lanyard, or to have the body linking means 110 comprise a magnetic or spring-closed clip for attachment directly to a user's clothing, or a hook-and-loop attachment area for attachment to a corresponding hook-and-loop attachment area, which may be connected to a user's clothes, backpack or bag, or to another item.

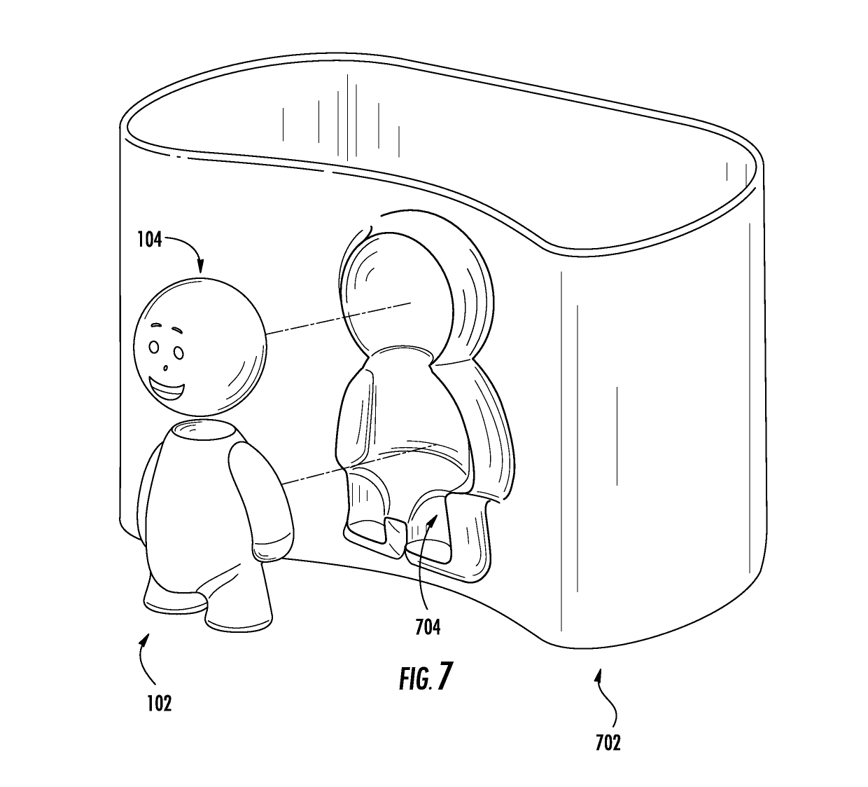

In a preferred embodiment of the inventive apparatus, it may be desirable to provide a figurine holder 704, as illustrated in FIG. 7, to securely hold and display the body 102 and a reversibly connected one of the plurality of emotion exhibiters 104. Said figurine holder 704 may comprise a flexible plastic or other material, sized and shaped to be able to receive an assembled figurine, said assembled figurine comprising a body 102 and one of the plurality of emotion exhibiters 104, with said figurine holder 704 able to securely contain and hold the said assembled figurine, and with said figurine holder 704 able to release the said assembled figurine when the user grasps said assembled figurine and pulls said assembled figurine away from the figurine holder 704. In preferred embodiments of the present invention, the figurine holder 704 is affixed to or made part of means for holding and transporting said figurine holder 704, referred to herein as a figurine holder transport 702. Said figurine holder transport 702 may comprise an armband or other suitable and convenient form or method of holding and/or carrying said figurine holder transport 702. Such a figurine holder transport 702 may have a hook-and-loop for convenient use and placement on a user's person or items, or, as will be obvious to one skilled in the art, a figurine holder transport 702 may have other forms and methods of use and closure in various embodiments of the present invention.

Certain embodiments of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, I claim:

1. An apparatus for communicating a plurality of emotions by displaying a plurality of visual representations of emotions, said apparatus comprising:
a body;
a plurality of emotion exhibiters;
connection means for reversibly connecting said plurality of emotion exhibiters to said body; and
organizing means for organizing said plurality of emotion exhibiters.

2. The apparatus of claim 1, in which said body further comprises a shape resembling a rounded humanoid torso, arms, and legs.

3. The apparatus of claim 1, in which said body further comprises a shape resembling a flattened outline of a humanoid torso, arms, and legs.

4. The apparatus of claim 1, in which said plurality of emotion exhibiters further comprise a shape resembling a rounded humanoid head.

5. The apparatus of claim 1, in which said plurality of emotion exhibiters further comprise a shape resembling a flattened outline of a humanoid head.

6. The apparatus of claim 1, in which said plurality of emotion exhibiters further comprise a plurality of facial features.

7. The apparatus of claim 6, in which said plurality of facial features comprise elevational changes from the surface of said plurality of emotion exhibiters.

8. The apparatus of claim 6, in which said plurality of facial features comprise variations on the surface of said plurality of emotion exhibiters.

9. The apparatus of claim 1, in which said connection means further comprise a plurality of magnets, in which
a plurality of magnets are suitably disposed within the body, and
a plurality of magnets are suitably disposed within the plurality of emotion exhibiters, such that
the body may be reversibly connected with the plurality of emotion exhibiters, and
the plurality of emotion exhibiters may each be aligned in a plurality of desired orientations relative to the body upon reversible connection with the body.

10. The apparatus of claim 1, in which said connection means further comprise an indentation and corresponding protrusion, in which
said indentation is in the upper surface of the area of the body analogous to the neck of a humanoid, and
said corresponding protrusion is from the lower surface of the plurality of emotion exhibiters analogous to the neck of a humanoid, such that
said indentation and said protrusion are sized and oriented to align the plurality of emotion exhibiters in a plurality of desired orientations relative to the body upon reversible connection with the body.

11. The apparatus of claim 1, in which said connection means further comprise a plurality of hook-and-loop areas, in which
a first plurality of said hook-and-loop areas are positioned on the body, and
a second plurality of said hook-and-loop areas are positioned on the plurality of emotion exhibiters, such that
said first plurality of body hook-and-loop areas and said second plurality of emotion exhibiter hook-and-loop areas are sized and oriented to align the plurality of emotion exhibiters in a plurality of desired orientations relative to the body upon reversible connection with the body.

12. The apparatus of claim 1, in which said means for organizing a plurality of emotion exhibiters comprises a plurality of holes through each of the plurality of emotion exhibiters, oriented such that an organizing rope can be threaded through a plurality of the emotion exhibiters.

13. The apparatus of claim 1, in which said means for organizing a plurality of emotion exhibiters comprises a plurality of magnets in a plurality of emotion exhibiters, oriented such that a plurality of emotion exhibiters can be reversibly connected to one or more of the other emotion exhibiters.

14. The apparatus of claim 1, in which said means for organizing a plurality of emotion exhibiters comprises a carrier item with carrier attachment means to reversibly connect a plurality of emotion exhibiters.

15. The apparatus of claim 14, in which said carrier item further comprises magnets disposed throughout said carrier item, said magnets being oriented to reversibly connect to corresponding magnets in a plurality of emotion exhibiters and to orient the plurality of emotion exhibiters in a desired manner.

16. The apparatus of claim 1, in which said means for organizing a plurality of emotion exhibiters comprises a container into which a plurality of emotion exhibiters may be placed.

17. The apparatus of claim 1, in which said body further comprises body linking means for reversibly connecting said body to another object.

18. The apparatus of claim 17, in which said body linking means further comprise means for attaching an external cord to said body.

19. An apparatus for communicating a plurality of emotions by displaying a plurality of visual representations of emotions, said apparatus comprising:
a body;
a plurality of emotion exhibiters; and
connection means for reversibly connecting said plurality of emotion exhibiters to said body.

20. An apparatus for communicating a plurality of emotions by displaying a plurality of visual representations of emotions, said apparatus comprising:
a body;
a plurality of emotion exhibiters;
connection means for reversibly connecting said plurality of emotion exhibiters to said body; and
a figurine holder to securely hold and display the body and a reversibly connected emotion exhibiter from said plurality of emotion exhibiters.

21. The apparatus of claim 20, in which the apparatus further comprises means for holding and transporting said figurine holder.
